(19) United States
(12) Patent Application Publication
(10) Pub. No.: US 2026/0319650 A1
(43) Pub. Date: Oct. 15, 2026

(54) CONTENT EDITING METHOD

(71) Applicant: Tencent Technology (Shenzhen) Company Limited, Shenzhen (CN)

(72) Inventor: Chenghao YE, Shenzhen (CN)

(73) Assignee: Tencent Technology (Shenzhen) Company Limited, Shenzhen (CN)

(21) Appl. No.: 19/681,038

(22) Filed: May 18, 2026

Related U.S. Application Data
(63) Continuation of application No. PCT/CN2025/107309, filed on Jul. 7, 2025.

(30) Foreign Application Priority Data
Aug. 23, 2024 (CN) 202411170165.3

(51) Int. Cl. G06F 3/04847; G06F 3/0482; G06F 3/04855; G06F 40/166; G11B 27/031

(52) U.S. Cl. CPC G06F 3/04847; G06F 3/0482; G06F 3/04855; G06F 40/166; G11B 27/031

(57) ABSTRACT

In a content editing method, an operation management control element corresponding to first content is displayed. A slider component element is displayed when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment. In the method, a first revision of the first content at a first moment represented by a first operation node is displayed when the slider control element indicates selection of the first operation node from the at least one historical operation node.

### RELATED APPLICATIONS

The present application is a continuation of International Application No. PCT/CN2025/107309, filed on Jul. 7, 2025, which claims priority to Chinese Patent Application No. 202411170165.3, filed on Aug. 23, 2024, and entitled "CONTENT EDITING METHOD AND APPARATUS, DEVICE, MEDIUM, AND PRODUCT." The entire disclosures of the prior applications are hereby incorporated by reference.

### FIELD OF THE TECHNOLOGY

This disclosure relates to the field of computer technologies, including content editing methods and apparatuses, devices, non-transitory computer-readable storage media, and products.

### BACKGROUND

When content is produced through an electronic product such as a computer, a tablet, or a mobile phone, complex work, such as document editing, drawing, and modeling, may be divided into individual steps. Each step has a result impact on the produced content. As a fault tolerance measure in a content production process, undo and redo operations may be basic but indispensable functions.

In some applications, an undo widget/shortcut key and a redo widget/shortcut key are provided to provide the undo and redo operations. In some examples, a user clicks the undo widget to recall content to a state corresponding to a previous operation, and clicks the redo widget to restore the recalled content.

However, when the user wants to undo a plurality of previous steps, the user may apply consecutive clicks/taps on the undo control or the undo shortcut key. Consequently, a client (e.g., a terminal device) may receive a plurality of triggering signals to implement a user requirement. Interaction efficiency of function implementation is relatively low.

### SUMMARY

Embodiments of this disclosure include content editing methods and apparatuses, devices, non-transitory computer-readable storage media, and products. Technical solutions are as follows.

According to an aspect, a content editing method is provided. In the method, an operation management control element corresponding to first content in a process of editing the first content is displayed. A slider component element is displayed when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment. In the method, when the slider component element is displayed, a sliding operation on the slider component element corresponding to moving the slider control element along the slider progress bar is received, and a first revision of the first content at a first moment represented by a first operation node is displayed when the slider control element indicates selection of the first operation node from the at least one historical operation node. In the method, a second revision of the first content at a second moment adjacent to a currently displayed revision of the first content at a currently displayed moment is displayed when a second triggering operation is performed on the operation management control element.

According to an aspect, a content editing apparatus is provided. The content editing apparatus includes processing circuitry configured to display an operation management control element corresponding to first content in a process of editing the first content. The processing circuitry is configured to display a slider component element when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment. The processing circuitry is configured to, when the slider component element is displayed, receive a sliding operation on the slider component element corresponding to moving the slider control element along the slider progress bar, and display a first revision of the first content at a first moment represented by a first operation node when the slider control element indicates selection of the first operation node from the at least one historical operation node. The processing circuitry is configured to display a second revision of the first content at a second moment adjacent to a currently displayed revision of the first content at a currently displayed moment when a second triggering operation is performed on the operation management control element.

According to an aspect, a non-transitory computer-readable storage medium is provided. The non-transitory computer-readable storage medium stores instructions, which when executed by a processor, cause the processor to perform a content editing method. In the method, an operation management control element corresponding to first content in a process of editing the first content is displayed. A slider component element is displayed when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment. In the method, when the slider component element is displayed, a sliding operation on the slider component element corresponding to moving the slider control element along the slider progress bar is received, and a first revision of the first content at a first moment represented by a first operation node is displayed when the slider control element indicates selection of the first operation node from the at least one historical operation node. In the method, a second revision of the first content at a second moment adjacent to a currently displayed revision of the first content at a currently displayed moment is displayed when a second triggering operation is performed on the operation management control element.

According to an aspect, a content editing method is provided, where the method is performed by a computer device, the method including: displaying a slider component element corresponding to first content in a process of editing the first content, the slider component element including at least one historical operation node, and the historical operation node being a node that is recorded in a historical period and that is generated when a content editing operation is performed on the first content; receiving a sliding operation on the slider component element, the sliding operation being configured to determine a first operation node from the at least one historical operation node; and displaying first historical content based on the first operation node, the first operation node being a node generated according to a first content editing operation recorded at a first moment in the historical period, and the first historical content being content obtained after a first content editing operation is performed on the first content at the first moment.

According to another aspect, a content editing apparatus is provided, where the apparatus includes: a display module, configured to display a slider component element corresponding to first content in a process of editing the first content, the slider component element including at least one historical operation node, and the historical operation node being a node that is recorded in a historical period and that is generated when a content editing operation is performed on the first content; a receiving module, configured to receive a sliding operation on the slider component element, the sliding operation being configured to determine a first operation node from the at least one historical operation node; and the display module is further configured to display first historical content based on the first operation node, the first operation node being a node generated according to a first content editing operation recorded at a first moment in the historical period, and the first historical content being content obtained after a first content editing operation is performed on the first content at the first moment.

According to another aspect, a computer device is provided, where the computer device includes a processor and a memory, the memory storing at least one instruction, at least one segment of program, and a code set or an instruction set, and the at least one instruction, the at least one segment of program, and the code set or the instruction set being loaded and executed by the processor to implement the content editing methods according to one or more embodiments of this disclosure.

According to another aspect, a non-transitory computer-readable storage medium is provided, where the storage medium stores at least one instruction, at least one segment of program, and a code set or an instruction set, the at least one instruction, the at least one segment of program, and the code set or the instruction set being loaded and executed by processing circuitry (e.g., a processor) to implement the content editing methods according to one or more embodiments of this disclosure.

According to another aspect, a computer program product or a computer program is provided, the computer program product or the computer program including a computer instruction, the computer instruction being stored in a non-transitory computer-readable storage medium. Processing circuitry (e.g., a processor) of a computer device reads the computer instruction from the non-transitory computer-readable storage medium and executes the computer instruction to cause the computer device to implement the content editing methods according to one or more embodiments of this disclosure.

The technical solutions provided in this disclosure at least include the following.

In a process of editing content, when a content editing operation performed on the content needs to be undone or redone, current content is reverted or restored to historical content (e.g., previous revisions) under content editing operations corresponding to different historical operation nodes in a historical period through a sliding operation for a slider component element. In this way, in one aspect, a user can quickly implement a multi-operation undo or redo operation through the slider component element, thereby improving efficiency of interaction implemented by undo and redo functions. In some aspects, because the computer device may detect an operation signal of the sliding operation to determine a quantity of undone or redone operation steps, redundant processing of an intermediate operation performed by receiving triggering signals for a plurality of times may be omitted, thereby reducing a quantity of operations detected by the computer equipment. In some aspects, the computer device may determine a first operation node according to the sliding operation for the slider component element, and directly presents corresponding first historical content based on the first operation node. In this way, in a scenario of multi-operation undo or redo, historical content corresponding to an intermediate operation that needs to be reverted when the computer device responds to each operation may be omitted, and a data processing amount in response to multi-operation undo or redo operations may be reduced.

### BRIEF DESCRIPTION OF THE DRAWINGS

FIG. 1 is a structural block diagram of a computer system according to an embodiment of this disclosure.

FIG. 2 is a flowchart of a content editing method according to an embodiment of this disclosure.

FIG. 3 is a schematic diagram of a slider component element according to an embodiment of this disclosure.

FIG. 4 is a schematic diagram of a slider component element according to an embodiment of this disclosure.

FIG. 5 is a schematic diagram of a content editing process according to an embodiment of this disclosure.

FIG. 6 is a flowchart of a content editing method according to an embodiment of this disclosure.

FIG. 7 is a schematic diagram of a content editing process according to an embodiment of this disclosure.

FIG. 8 is a flowchart of a content editing method according to an embodiment of this disclosure.

FIG. 9 is a schematic diagram of a display style of an operation management control element according to an embodiment of this disclosure.

FIG. 10 is a schematic flowchart of precise undo and redo functions implemented by using a slider component element according to an embodiment of this disclosure.

FIG. 11 is a flowchart of determining logic of an operation management control element according to an embodiment of this disclosure.

FIG. 12 is a structural block diagram of a content editing apparatus according to an embodiment of this disclosure.

FIG. 13 is a structural block diagram of a content editing apparatus according to an embodiment of this disclosure.

FIG. 14 is a structural block diagram of a terminal according to an embodiment of this disclosure.

### DETAILED DESCRIPTION

Descriptions of terms in this disclosure are provided as examples and are not intended to limit the scope of the disclosure.

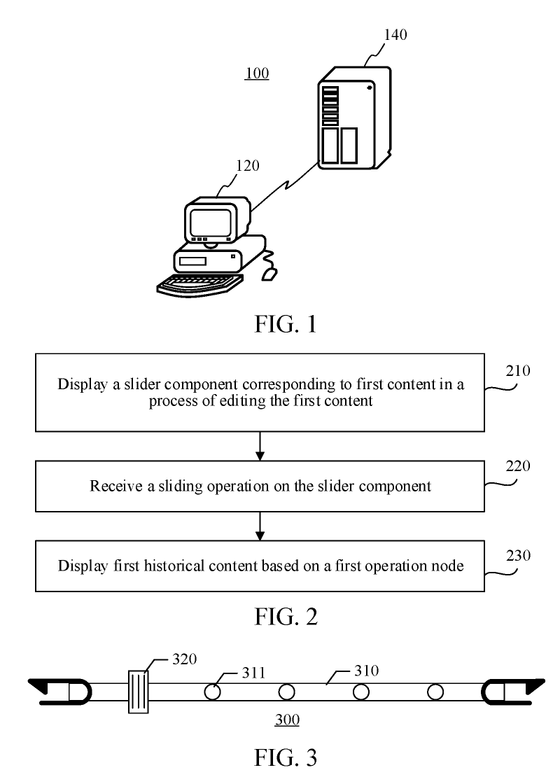

FIG. 1 is a structural block diagram of a computer system according to an embodiment of this disclosure. The computer system 100 includes a terminal 120 and a server 140.

An application program providing a content production function is installed and run on the terminal 120. The application program may be any one of a document editing application, an image processing application, a video clipping application, an audio editing application, a modeling application, and the like.

A device type of the terminal 120 includes at least one of a game console, a desktop computer, a smartphone, a tablet computer, an e-book reader, a moving picture experts group audio layer III (MP3) player, a moving picture experts group layer IV (MP4) player, or a laptop computer. In one or more of the following embodiments, an example in which the terminal is a desktop computer is described.

The terminal 120 is connected to a server 140 through a wireless network or a wired network.

A person skilled in the art may learn that a quantity of devices may be larger or smaller. For example, there may be only one device, or there may be dozens of or hundreds of or more devices. The quantity and type of the devices are not limited in this disclosure.

The server 140 includes at least one of one server, a plurality of servers, a cloud computing platform, or a virtualization center. The server 140 is configured to provide a backend service for an application program supporting a three-dimensional virtual environment. In some embodiments, the server 140 is responsible for primary computing work, and the terminal 120 is responsible for secondary computing work; the server 140 is responsible for the secondary computing work, and the terminal 120 is responsible for the primary computing work; or a distributed computing architecture is adopted between the server 140 and the terminal 120 to perform collaborative computing.

The server 140 may be implemented as a physical server or as a cloud server in a cloud.

In some aspects, a client of a content production application in the terminal 120 provides the content production function for a user. In a process of editing current content through the content production function, the client provides a slider component element corresponding to the current content for the user. When needing to undo or redo the current content, the user triggers a sliding operation on the slider component element. In some examples, the sliding operation corresponds to moving the slider control element along the slider progress bar. The client determines a first operation node from the at least one historical operation node corresponding to the current content according to the sliding operation, and undoes or redoes the current content (also referred to as a current revision of a content or a currently displayed revision of the content) to first historical content (also referred to as a previous revision of the content) at a first moment in a historical period. The first moment is a recording moment corresponding to the first operation node.

In some embodiments, the content editing method provided in the embodiments of this disclosure may be independently implemented by the client in the terminal 120. In other words, a client of the content production application processes a functional service in a content editing process in an offline manner. In some embodiments, the content editing method provided in the embodiments of this disclosure may be cooperatively implemented by the client in the terminal 120 and the server 140. In other words, the client of the content production application processes the functional service in the content editing process in an online manner. In some aspects, the server 140 is configured to record a historical operation node corresponding to content in the content editing process, and provide related data corresponding to the historical operation node to the client when required by the client.

In some embodiments, the server 140 may alternatively be implemented as a node in a blockchain system.

The content editing method provided in this disclosure is described with reference to the foregoing introduction of terms and the application scenario. An example in which the method is performed by a computer device (for example, the terminal 120 in FIG. 1) is used for description. As shown in FIG. 2, the method includes the following operation 210 to operation 230.

Operation 210: Display a slider component element corresponding to first content in a process of editing the first content. In some examples, an operation management control element corresponding to first content in a process of editing the first content is displayed. In some examples, a slider component element is displayed when a first triggering operation is performed on the operation management control element. In some examples, the slider component element includes a slider progress bar, a slider control element over the slider progress bar, and at least one historical operation node. In some examples, each of the at least one historical operation node represents a revision of the first content at a respective moment within a recording period that is generated when a content editing operation is performed on the first content at the respective moment.

In this embodiment of this disclosure, a content production application is run on a terminal. In some embodiments, the content production application may be implemented as any one of a document editing application, an image processing application, a video clipping application, an audio editing application, a modeling application, and the like. The content production application is configured to provide a user with a content production function, such as document editing, image processing, video clipping, and audio editing.

In some aspects, the terminal runs the content production application, to provide a content editing interface for the user. The user implements the process of editing the first content in the content editing interface.

In some embodiments, a content form of the first content may be implemented as at least one of a text form, a voice form, an image form, or a video form.

In this embodiment of this disclosure, the slider component element is a function component that is provided by the content production application and that manages a historical editing operation on the first content. In other words, the slider component element is a component that provides undo and redo functions, and may roll back the first content from a current state to a historical state, or restore the first content obtained after the rollback to the current state.

In some embodiments, the slider component element is a component directly displayed on the content editing interface. In other words, in the process of editing the first content, the slider component element is displayed on the content editing interface. In some embodiments, the slider component element is invoked by using a component invoking operation. In some aspects, in the process of editing the first content, the component invoking operation performed on the slider component element is received, and the slider component element is displayed in response to the component invoking operation. The component invoking operation may be implemented through at least one of a control, a shortcut key, or a gesture operation.

In this embodiment of this disclosure, the slider component element includes at least one historical operation node, the historical operation node being a node that is recorded in a historical period and that is generated when a content editing operation is performed on the first content.

In some embodiments, a quantity of historical operation nodes included in the slider component element is related to a quantity of content editing operations received in the historical period. In some embodiments, a corresponding historical operation node is recorded for each content editing operation in the historical period. In some embodiments, the quantity of historical operation nodes included in the slider component element is related to a period length of the historical period. In some embodiments, the historical period is divided by using first duration as a division unit, and a content editing operation corresponding to each time node obtained through division is recorded, to obtain a historical operation node corresponding to the time node.

In some embodiments, the historical period may be implemented as a period in which a creation moment of the first content is used as a starting moment and a current moment is used as an end moment. In some embodiments, the historical period may be implemented as a period obtained by using a current moment as an end moment and tracing backward by specified duration, for example, by ten minutes.

In some embodiments, the historical period may be a period preset by a client, or may be a user-defined period.

In some embodiments, when the historical period is implemented as the user-defined time period, the user sets, by using a setting interface provided by the content production application, a historical period corresponding to the historical operation node presented by the slider component element. In some aspects, the setting interface is displayed. The setting interface includes a period setting control for setting a historical period corresponding to the undo and redo functions. Based on a period setting operation received by the period setting control, the client records the content editing operation and generates the historical operation node based on the historical period indicated by the period setting operation.

In some embodiments, when the content production application is implemented as a document editing application, the content editing operation is implemented as an editing processing operation on document content, such as text input, table generation, font modification, or content replacement.

In some other embodiments, when the content production application is implemented as an image processing application, the content editing operation is implemented as an editing processing operation performed on image content, such as image cutting, image stitching, pattern drawing, and layer creation.

In some other embodiments, when the content production application is implemented as a video clipping application, the content editing operation is implemented as an editing processing operation performed on video content, such as video cutting, speed adjustment, a transition effect, audio track processing, or subtitle addition.

In some other embodiments, when the content production application is implemented as an audio editing application, the content editing operation is implemented as an editing processing operation on audio content, such as recording, instrument sound synthesizing, beat production, or drum programming.

Operation 220: Receive a sliding operation on the slider component element. For example, when the slider component element is displayed, a sliding operation on the slider component element corresponding to moving the slider control element along the slider progress bar is received.

In some aspects, the sliding operation is configured to determine the first operation node from the at least one historical operation node. In other words, the client determines the first operation node from the at least one historical operation node based on the received sliding operation on the slider component element.

In some embodiments, the sliding operation may be implemented as a touch sliding operation performed on the slider component element received by a screen of the terminal. Alternatively, the sliding operation may be implemented as a shortcut key triggering operation performed on the slider component element that is received by a physical key or an external input device of the terminal. For example, the terminal receives a long-press and dragging operation collected by a mouse performed on the slider component element. Alternatively, the sliding operation may be implemented as a sliding gesture operation recognized by the terminal through a camera. For example, a virtual reality (VR) device detects that the user gazes at the slider component element, and determines that the sliding operation performed on the slider component element is received when detecting a pinch and dragging gesture of the user through image recognition.

In some embodiments, the slider component element includes a slider progress bar and a slider control element. The slider progress bar is configured to indicate an operation range in which the undo and redo functions can be implemented, and the slider control element is configured to receive a sliding operation to determine the first operation node.

In some aspects, a sliding operation performed on the slider control element on the slider progress bar is received. The first operation node is determined based on a sliding end position of the sliding operation on the slider progress bar. For example, whether the slider control element indicates the selection of the first operation node is determined based on a sliding end position of the sliding operation on the slider progress bar. In other words, a computer device can determine a quantity of operation steps that are undone/redone by detecting the sliding end position of the sliding operation on the slider progress bar. In this way, a quantity of operations detected by the computer device may be reduced, and a data processing amount in response to the operation may be reduced.

In some embodiments, corresponding distribution of historical operation nodes on the slider progress bar may be implemented as at least one type of the following.

A first type is discrete distribution.

In some aspects, the historical operation nodes are discretely distributed on the slider progress bar. In other words, when the user moves the slider control element, a sliding end position of the slider control element is implemented as a target fixed node position among a plurality of fixed node positions on the slider progress bar. The fixed node position is in a one-to-one correspondence with the historical operation node.

In some embodiments, the plurality of fixed node positions are evenly distributed on the slider progress bar. In other words, the plurality of historical operation nodes are distributed at specified distance intervals on the slider progress bar. In some embodiments, the plurality of fixed node positions are unevenly distributed on the slider progress bar. In some embodiments, a corresponding historical operation node is displayed on the slider progress bar based on distribution of the historical operation nodes in the historical period. In other words, a longer time interval between two historical operation nodes in the historical period indicates a longer position interval between two historical operation nodes on the slider progress bar.

A second type is continuous distribution.

In some aspects, when the user moves the slider control element, the sliding end position of the slider control element may be implemented as any position on the slider progress bar. A corresponding historical operation node is determined based on the sliding end position of the slider control element, to obtain the first operation node.

In some embodiments, a first relative position relationship between the sliding end position of the slider control element and the slider progress bar corresponds to a second relative position relationship between a first moment corresponding to the first operation node and the historical period. In some aspects, the first moment in the historical period is determined based on the sliding end position of the slider control element, and a node that is recorded at the first moment and that is generated when a first content editing operation is performed on the first content is determined as the first operation node. For example, if the historical period is ten minutes before the current moment, and the sliding end position is an intermediate position of the slider progress bar, it is determined that a corresponding first moment is five minutes ago. In this way, a node generated when the content editing operation is recorded five minutes ago is determined as the first operation node.

In some embodiments, a node identifier corresponding to each historical operation node is displayed in the slider component element. In some embodiments, the node identifier may be implemented as an identifier in at least one form of a text form, a pattern form, a video form, and a voice form.

In some embodiments, the node identifier may be displayed on the slider progress bar. FIG. 3 is a schematic diagram of a slider component element 300 according to an embodiment of this disclosure. The slider component element 300 includes a slider progress bar 310 and a slider control element 320. The slider progress bar 310 includes node identifiers 311 corresponding to a plurality of historical operation nodes. A user may move the slider control element 320 to different historical operation nodes to implement the undo and redo functions.

In some embodiments, when the node identifier is displayed on the slider progress bar, to avoid a blocking problem, screen blocking detection is performed when the node identifier is displayed. In some aspects, screen blocking detection is performed based on the sliding operation, to obtain screen blocking information, the screen blocking information being configured to indicate an area in which a screen is blocked when the sliding operation is received. Sliding path detection is performed based on the sliding operation, to obtain a sliding path corresponding to the sliding operation. A node identifier of a historical operation node passed on the sliding path is displayed based on the screen blocking information and the sliding path.

In some embodiments, when the screen blocking information indicates that a first display position corresponding to the historical operation node passed on the sliding path is blocked, the node identifier of the passed historical operation node is displayed at the second display position. The first display position is a default display position of the node identifier. In other words, when the screen blocking information indicates that blocking exists at the default display position corresponding to the node identifier of the historical operation node, the second display position in which no blocking exists is determined based on the screen blocking information, and the node identifier corresponding to the historical operation node is displayed at the second display position.

In some embodiments, when the node identifier corresponding to the historical operation node is displayed at the target display position, node guidance information between the target display position and the historical operation node is further displayed. The node guidance information is configured to perform an association indication on the node identifier of the target display position and the historical operation node.

In an example, when detecting the sliding operation, a sensor in a display screen of the terminal simultaneously detects blocking of the screen caused by an operation gesture when the sliding operation is triggered. For example, a distance sensor detects a distance between a hand of the user and the screen in an area corresponding to the screen, and determines the blocking of the screen caused by the gesture based on the distance. For example, when the distance between the hand and the screen is less than a preset distance threshold, it is determined that the hand of the user blocks the screen. In other words, a display position of the node identifier is determined through the screen blocking detection, thereby avoiding the blocking problem that occurs when the sliding operation is received during display of the historical operation node on the slider progress bar.

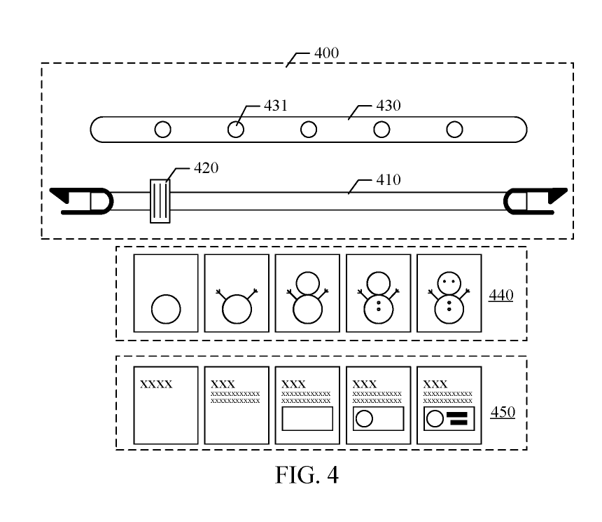

In some embodiments, the node identifier is displayed through an additional reference ruler. In other words, the slider component element includes the slider progress bar, the slider control element, and the reference ruler. The slider control element slides on the slider progress bar, and the reference ruler is configured to display the node identifier corresponding to the historical operation node. FIG. 4 is a schematic diagram of a slider component element 400 according to an embodiment of this disclosure. The slider component element 400 includes a slider progress bar 410, a slider control element 420, and a reference ruler 430. The reference ruler 430 includes node identifiers 431 corresponding to a plurality of historical operation nodes.

In some aspects, an example in which the content production application is implemented as a drawing application is used. FIG. 4 shows a correspondence 440 between the slider component element 400 and content of the first content at different historical operation nodes. In another example, an example in which the content production application is implemented as a document editing application is used. FIG. 4 shows a correspondence 450 between the slider component element 400 and the content of the first content in the different historical operation nodes.

Operation 230: Display first historical content (e.g., a previous revision) based on the first operation node. For example, when the slider component element is displayed, a first revision of the first content at a first moment represented by a first operation node is displayed when the slider control element indicates selection of the first operation node from the at least one historical operation node.

In this embodiment of this disclosure, the first operation node is a node generated according to a first content editing operation recorded at the first moment in the historical period, the first historical content being content obtained after the first content editing operation is performed on the first content at the first moment.

In some examples, a second revision of the first content at a second moment adjacent to a currently displayed revision of the first content at a currently displayed moment is displayed when a second triggering operation is performed on the operation management control element.

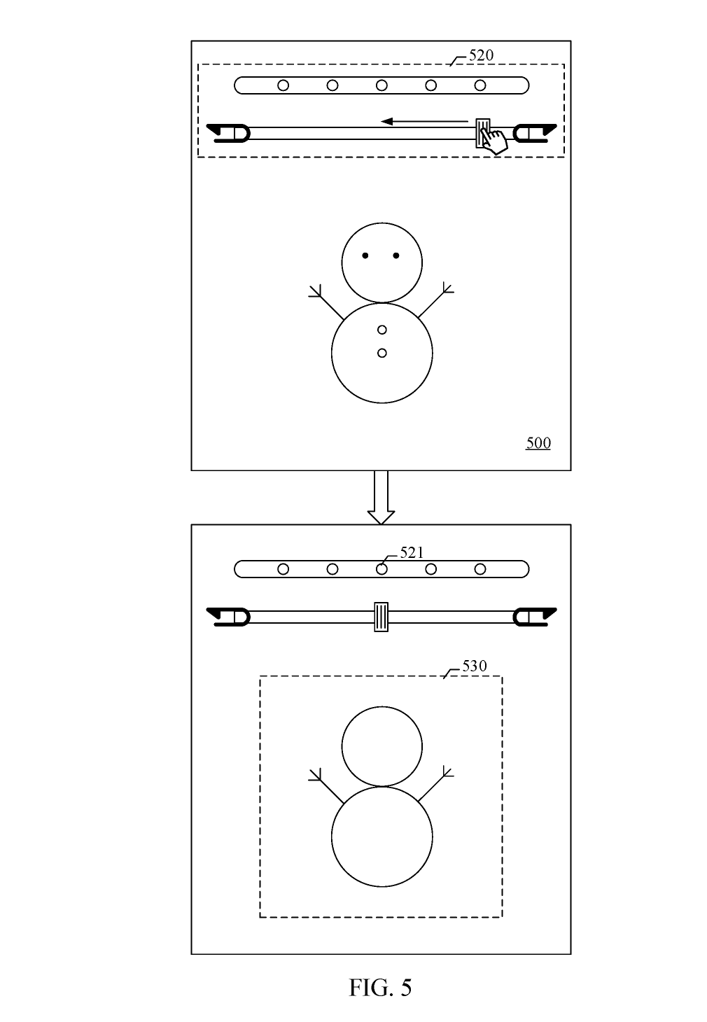

FIG. 5 is a schematic diagram of a content editing process according to an embodiment of this disclosure. The first content and a slider component element 520 are displayed on a content editing interface 500. When a moving operation of the user on the slider component element 520 is received, first historical content 530 corresponding to a first operation node 521 is displayed based on the first operation node 521 indicated by the moving operation. The first historical content 530 is content obtained after a first content editing operation is performed on the first content at the first moment.

In some embodiments, when a current operation node at which the first content is located before the sliding operation is received is a latest operation node in all historical operation nodes, the sliding operation is configured to implement the undo function. In other words, the first content is undone from current content corresponding to the current operation node to first historical content corresponding to the first moment.

In some other embodiments, when the current operation node at which the first content is located before the sliding operation is received is an intermediate operation node in all the historical operation nodes, the sliding operation is configured to implement the undo function or the redo function. In other words, the first content is undone from the current content corresponding to the current operation node to the first historical content corresponding to the first moment, where the first moment is a moment before a second moment at which the current operation node is recorded; or the first content is redone from the current content corresponding to the current operation node to the first historical content corresponding to the first moment, where the first moment is a moment after a second moment at which the current operation node is recorded.

In some other embodiments, when the current operation node at which the first content is located before the sliding operation is received is a last operation node in all the historical operation nodes, the sliding operation is configured to implement the redo function. In other words, the first content is redone from current content corresponding to the current operation node to the first historical content corresponding to the first moment.

In some embodiments, the first content corresponds to a node recording list, where the node recording list is configured to record an operation node of the first content in the editing process. In other words, the node recording list records the historical operation node corresponding to the first content.

In some aspects, when the current operation node at which the first content is located before the sliding operation is received is located at a head position in a queue of the node recording list, the sliding operation is configured to implement the undo function. In other words, the first content is undone from the current content corresponding to the current operation node to the first historical content corresponding to the first moment.

In some aspects, when the current operation node at which the first content is located before the sliding operation is received is located at an intermediate position in the queue of the node recording list, the sliding operation is configured to implement the undo function or the redo function. In other words, the first content is redone from the current content corresponding to the current operation node to the first historical content corresponding to the first moment. The first moment is a moment before the second moment at which the current operation node is recorded, or the first content is redone from the current content corresponding to the current operation node to the first historical content corresponding to the first moment, the first moment being a moment after the second moment at which the current operation node is recorded.

In some aspects, when the current operation node at which the first content is located before the sliding operation is received is located at a tail position in the queue of the node recording list, the sliding operation is configured to implement the undo function. In other words, the first content is redone from the current content corresponding to the current operation node to the first historical content corresponding to the first moment.

In some embodiments, the content production application displays current node content of the first content in the current operation node in the content editing interface. In response to the sliding operation, the client replaces the current node content on the content editing interface with the first historical content corresponding to the first operation node. In some other embodiments, in response to the sliding operation, the client displays the current node content and the first historical content on the content editing interface.

Therefore, in a process of editing content, when a content editing operation performed on the content needs to be undone or redone, current content is reverted or restored to historical content under content editing operations corresponding to different historical operation nodes in a historical period through a sliding operation performed on a slider component element. In this way, in one aspect, a user can quickly implement a multi-step undo or redo operation through the slider component element, thereby improving interaction efficiency of implementation of undo and redo functions. In another aspect, because the computer device may detect an operation signal of the sliding operation to determine a quantity of undone or redone operation steps, redundant processing of an intermediate step that would otherwise be performed by receiving triggering signals a plurality of times may be omitted, thereby reducing a quantity of times of operation detection by the computer device. In still another aspect, the computer device may determine a first operation node according to the sliding operation performed on the slider component element, and directly presents corresponding first historical content based on the first operation node. In this way, in a scenario of multi-step undo or redo, historical content corresponding to an intermediate operation that needs to be reverted when the computer device responds to each operation may be omitted, and a data processing amount in response to multi-step undo or redo operation may be reduced.

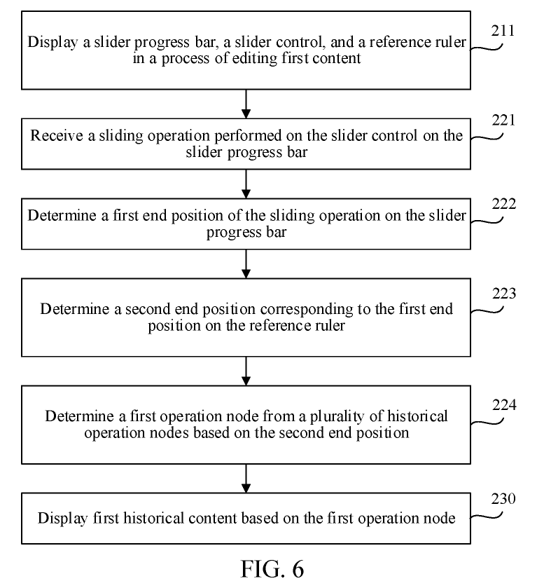

In some embodiments, the slider component element includes a slider progress bar, a slider control element, and a reference ruler, the slider control element is located on the slider progress bar to receive a sliding operation, and the reference ruler is configured to indicate a historical operation node that may be reverted or redone. Referring to FIG. 6, FIG. 6 is a flowchart of a content editing method according to an embodiment of this disclosure. This method includes operation 211 to operation 230.

Operation 211: Display the slider progress bar, the slider control element, and the reference ruler in a process of editing first content.

In this embodiment of this disclosure, the slider component element includes the slider progress bar, the slider control element, and the reference ruler. The slider progress bar is configured to indicate an operation range in which undo and redo functions can be implemented, and the slider control element is configured to receive a sliding operation to determine a first operation node. The reference ruler is configured to display reference points respectively corresponding to a plurality of historical operation nodes, facilitating a user to more easily and accurately learn a quantity of historical operation nodes and a position of a current operation node.

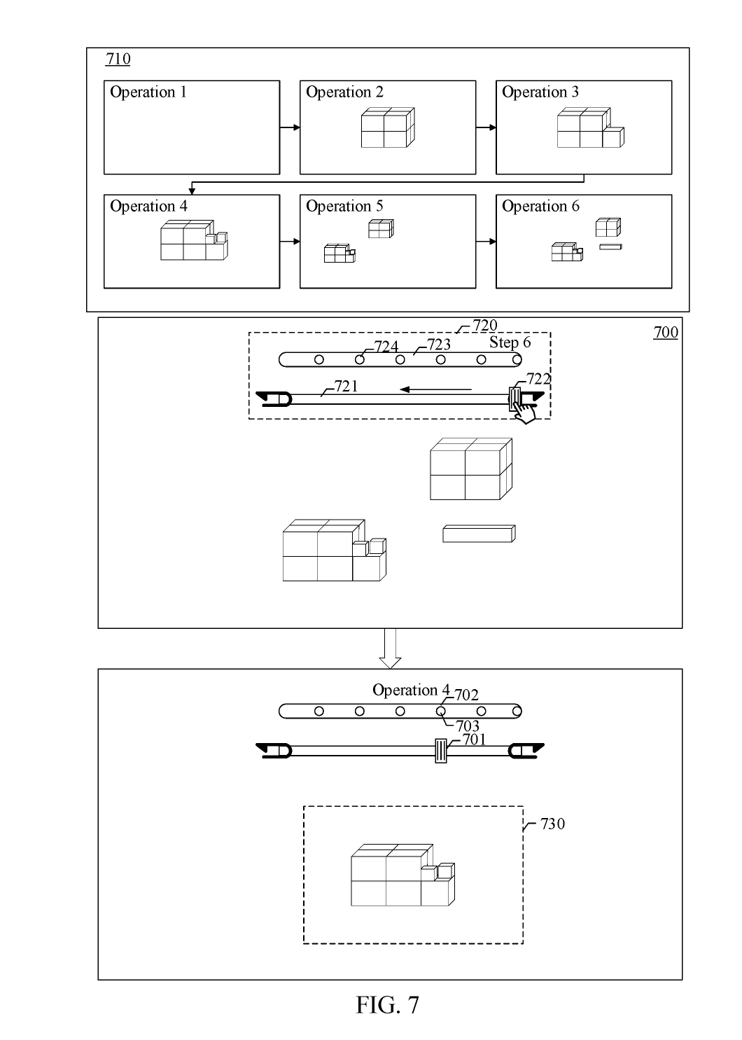

As shown in FIG. 7, FIG. 7 is a schematic diagram of a content editing process according to an embodiment of this disclosure. In this embodiment of this disclosure, an example in which a content production application is implemented as a modeling application is used. A user performs a modeling process 710 for 3D content through the modeling application. When the user stays at operation 6 and intends to recall to any one of operation 1 to operation 5, the user may implement the undo function through a slider component element 720. In some aspects, the slider component element 720 is displayed in the content editing interface 700. The slider component element 720 includes a slider progress bar 721, a slider control element 722, and a reference ruler 723. Historical operation nodes 724 respectively corresponding to operation 1 to operation 6 are displayed in the reference ruler 723.

Operation 221: Receive a sliding operation performed on the slider control element on the slider progress bar.

In some aspects, the sliding operation is configured to determine the first operation node from at least one historical operation node. In some embodiments, the foregoing sliding operation may be implemented as a touch sliding operation for the slider control element received by a screen of a terminal. Alternatively, the foregoing sliding operation may be implemented as a shortcut key triggering operation for the slider component element that is received by a physical key or an external input device of the terminal. For example, the terminal receives a long-press and dragging operation collected by a mouse for the slider control element. Alternatively, the foregoing sliding operation may be implemented as a sliding gesture operation recognized by the terminal through a camera. For example, a virtual reality (VR) device detects that the user gazes at the slider control element, and determines that the sliding operation for the slider control element is received when detecting a pinch and dragging gesture of the user through image recognition.

Operation 222: Determine a sliding end position of the sliding operation on the slider progress bar.

In this embodiment of this disclosure, the sliding end position is a position at which the slider control element stops moving when the user slides the slider control element. In some embodiments, an operation end moment corresponding to the sliding operation is determined based on a slider release signal corresponding to the sliding operation, and the sliding end position is determined based on a position of the slider control element on the slider progress bar at the operation end moment.

In some embodiments, the sliding end position may be implemented as any position on the progress slider (e.g., the historical operation nodes are continuously distributed on the progress slider). In some other embodiments, the sliding end position may be implemented as one of a plurality of candidate positions on the progress slider (e.g., the historical operation nodes are discretely distributed on the progress slider).

In some embodiments, a sliding range of the sliding operation on the slider progress bar is associated with a period length of the historical period. In some aspects, the sliding range is in a positive correlation with the period length of the historical period; and in some other embodiments, a sliding range of the sliding operation on the slider progress bar is associated with a node quantity of the historical operation node. In some aspects, the sliding range is in a positive correlation with the quantity of historical operation nodes.

Operation 223: Determine a reference position corresponding to the sliding end position on the reference ruler.

In this embodiment of this disclosure, the reference ruler is an auxiliary interface element for determining the historical operation node. In this embodiment of this disclosure, the reference ruler and the slider progress bar that are independent of each other are configured to avoid a case in which the historical operation node indicated on the slider progress bar is blocked from view on some operation media. For example, when a touch screen is triggered through a finger, related information of a currently selected first operation node may not be seen due to blocking caused by the finger.

In some embodiments, the reference ruler is located at an adjacent position of the slider progress bar. For example, the reference ruler is located above or below the slider progress bar. In an example, as shown in FIG. 7, the reference ruler 723 is displayed above the slider progress bar 721.

In some embodiments, the reference position is determined based on a relative position relationship, between the reference ruler and the slider progress bar, and the sliding end position. In an example, the relative position relationship between the reference ruler and the slider progress bar indicates that a position coordinate on the reference ruler is offset by n units relative to a position coordinate on the slider progress bar in a vertical axis direction, n being a positive integer. For example, if a position of the sliding end position in a specified coordinate system is (x0, y0), a position of the reference position in the specified coordinate system is (x0, y0+n).

In some embodiments, the reference ruler is displayed when the sliding operation is received by the slider control element, and the reference ruler is hidden when the slider release signal corresponding to the sliding operation is detected.

In some embodiments, operation information corresponding to each historical operation node is displayed on the reference ruler. In some embodiments, the operation information includes an operation name, an operation execution moment, a historical quantity of times of operation execution, and the like.

In some embodiments, based on a target operation node corresponding to a position at which the slider control element is located on the slider progress bar, operation information corresponding to the target operation node is displayed on the reference ruler. The target operation node may be implemented as an operation node corresponding to a position at which the slider control element stays, or may be implemented as an operation node through which the slider control element passes in a sliding operation process.

Operation 224: Determine the first operation node from the plurality of historical operation nodes based on the reference position.

In this embodiment of this disclosure, the reference ruler corresponds to candidate node positions respectively corresponding to the plurality of historical operation nodes, and the first operation node is determined based on a matching situation between the second end point position and the candidate node position.

In some embodiments, a target node position closest to the reference position is determined from a plurality of candidate node positions, and a historical operation node corresponding to the target node position is determined as the first operation node.

As shown in FIG. 7, the user moves the slider control element 722 from an initial position corresponding to operation 6 to a sliding end position 701. A reference position 702 corresponding to the sliding end position 701 is determined on the reference ruler 723, and a first operation node 703 closest to the reference position 702 is determined from the historical operation node 724 based on the reference position 702. The first operation node 703 is an operation node corresponding to operation 4.

In some embodiments, the reference ruler includes reference scales respectively corresponding to the plurality of historical operation nodes, and the first operation node is determined from the plurality of historical operation nodes based on the reference scales corresponding to the reference position. The reference scale is a mark, on the reference ruler, configured to read a historical operation node indicated by the slider control element on the slider progress bar.

In some aspects, a reference scale corresponding to the reference position is recognized from the reference ruler, and a first operation node associated with the reference scale corresponding to the reference position is obtained. In an example, a reference scale corresponding to the reference position is recognized from the reference ruler according to a matching result between coordinate information of the reference position on the screen and coordinate information corresponding to each reference scale. Then, a table of a mapping relationship between a reference scale and an operation node that are generated in a process of editing the first content is obtained, and a first operation node associated with the reference scale corresponding to the reference position is queried and obtained from the table of the mapping relationship. The foregoing mapping table may enable quick querying and obtaining of the operation node corresponding to the reference scale that the user slides to, thereby improving efficiency of a computer device in determining historical content to be displayed during redo and undo processes.

Operation 230: Display first historical content based on the first operation node.

In this embodiment of this disclosure, the first operation node is a node generated according to a first content editing operation recorded at the first moment in the historical period, the first historical content being content obtained after a first content editing operation is performed on the first content at the first moment.

As shown in FIG. 7, if the first operation node 703 determined based on the reference position 702 is an operation node corresponding to operation 4, first historical content 730 under a content editing operation corresponding to operation 4 is displayed.

Therefore, in a process of editing content, when a content editing operation performed on the content needs to be undone or redone, current content is reverted or restored to historical content under content editing operations corresponding to different historical operation nodes in a historical period through a sliding operation for a slider component element. In this way, in one aspect, a user can quickly implement a multi-operation undo or redo operation through the slider component element, thereby improving efficiency of interaction implemented by undo and redo functions; in another aspect, because the computer device may detect an operation signal of the sliding operation to determine a quantity of undone or redone operation steps, redundant processing of an intermediate operation that would otherwise be performed by receiving triggering signals for a plurality of times may be omitted, thereby reducing a quantity of operations detected by the computer equipment; and in still another aspect, the computer device may determine a first operation node according to the sliding operation for the slider component element, and directly presents corresponding first historical content based on the first operation node. In this way, in a scenario of multi-operation undo or redo, historical content corresponding to an intermediate operation that needs to be reverted when the computer device responds to each operation may be omitted, and a data processing amount in response to multi-operation undo or redo operations may be reduced.

In this embodiment of this disclosure, the user may select the historical operation node by moving the slider control element on the slider progress bar, to quickly select the historical operation node. In addition, when detecting the sliding operation, a client may determine the selected first operation node by detecting a position of the slider control element at an end time point of a touch signal of the slider control element. In this way, efficiency of selecting the historical operation node may be improved. In addition, a signal detection amount of the computer device may be reduced, and a data processing amount of the computer device may be reduced.

In this embodiment of this disclosure, a reference ruler independent from the slider progress bar is configured to indicate a historical operation node that can be selected, avoiding a case in which historical operation node information may not be accurately obtained due to blocking when the sliding operation is implemented through the slider control element.

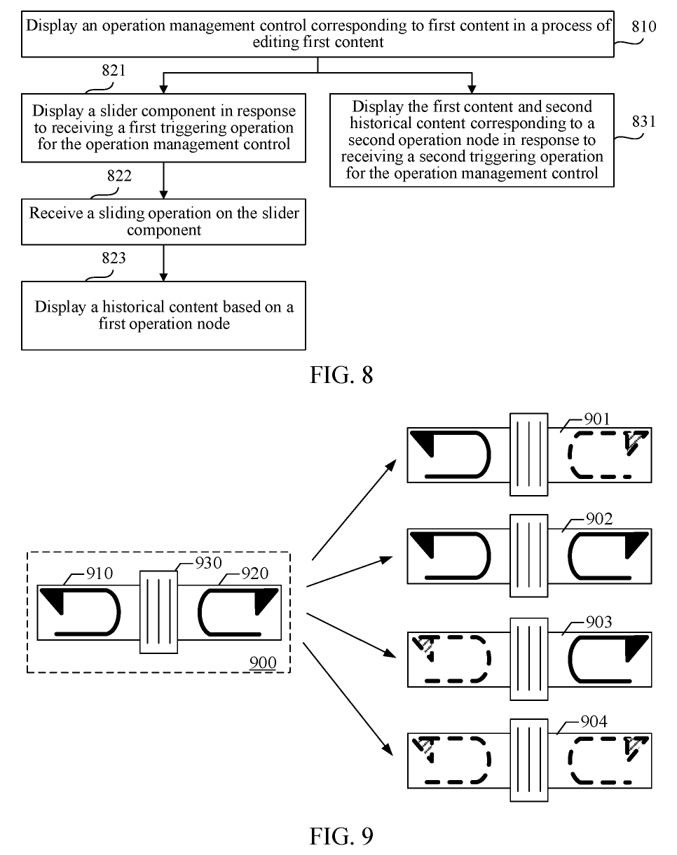

In some embodiments, an operation management control element is displayed on a terminal, to provide an undo function and a redo function for content. Referring to FIG. 8, FIG. 8 is a flowchart of a content editing method according to an embodiment of this disclosure. This method includes operation 810 to operation 831.

Operation 810: Display an operation management control element corresponding to first content in a process of editing the first content.

In this embodiment of this disclosure, the operation management control element is configured to manage a content editing operation of the first content in a historical period. In other words, the operation management control element is configured to implement the undo and redo functions.

In this embodiment of this disclosure, when the operation management control element provides the undo and redo functions, quick undo and redo and precise undo and redo are implemented for different received triggering operations. The precise undo and redo are functions implemented by invoking a slider component element.

In some embodiments, the operation management control element is displayed according to a position that is of a current content editing operation corresponding to a current operation node of the first content and that is in all received content editing operations. In some aspects, the first content corresponds to a node recording list. The node recording list is configured to record an operation node of the first content in an editing process, obtain a first recording position of the current operation node of the first content in the node recording list, and display an operation management control element associated with the first recording position.

In some embodiments, when a recording sequence of the operation node in the node recording list is negatively correlated to a display sequence (e.g., the closer a recording moment of an operation node is to a current time, the earlier the operation node is displayed in the node recording list), the following display rules may apply. In some aspects, an operation management control element in a first style is displayed when the first recording position is a head position in a queue of the node recording list, the operation management control element in the first style being configured to provide an operation undo function; an operation management control element in a second style is displayed when the first recording position is an intermediate position in the queue of the node recording list, the operation management control element in the second style being configured to provide the operation undo function and an operation redo function; and an operation management control element in a third style is displayed when the first recording position is a tail position in the queue of the node recording list, the operation management control element in the third style being configured to provide the operation redo function.

In some embodiments, when the recording sequence of the operation node in the node recording list is positively correlated to the display sequence (e.g., the closer a recording moment of an operation node is to a current time, the later the operation node is displayed in the node recording list, and the operation nodes are sequentially recorded into the node recording list according to an operation moment of a corresponding content editing operation), the following display rules may apply. In some aspects, an operation management control element in the third style is displayed when the first recording position is the head position in the queue of the node recording list, the operation management control element in the third style being configured to provide the operation redo function; the operation management control element in the second style is displayed when the first recording position is the intermediate position in the queue of the node recording list, the operation management control element in the second style being configured to provide the operation undo function and the operation redo function; and the operation management control element in the third style is displayed when the first recording position is the tail position in the queue of the node recording list, the operation management control element in the third style being configured to provide the operation redo function.

In other words, an operation management control element in a corresponding style is dynamically displayed according to a position of a current operation node in all operation nodes. In this way, the user can quickly learn a capability operation that can be performed by current first content according to a display style of the operation management control element, thereby improving efficiency of information transfer in an interface, and improving efficiency of human-computer interaction.

In some embodiments, when the node recording list is null, an operation management control element in a fourth style is displayed. The operation management control element in the fourth style indicates that no historical content of receiving undo or redo currently exists.

When operation management control elements in different styles are displayed through the position of the current operation node in the node recording list, the user may quickly learn the position of the current operation node in a plurality of historical operation nodes through the display style of the operation management control element. Further, the user may learn whether operation undo or operation redo can be performed, thereby improving information transmission efficiency.

In an example, as shown in FIG. 9, FIG. 9 is a schematic diagram of a display style of an operation management control element 900 according to an embodiment of this disclosure. An example in which the operation management control element 900 includes a first sub-control 910 and a second sub-control 920 is used. The first sub-control 910 is configured to provide the operation undo function, and the second sub-control 920 is configured to provide the operation redo function.

In some embodiments, the operation management control element 900 further includes a slider element 930. The slider element 930 is configured to indicate that the operation management control element 900 provides precise undo and redo functions. The operation management control element 900 may display the slider element 930, or may not display the slider element 930.

In some aspects, in an operation management control element 900 in a first style 901, the first sub-control 910 is in a triggerable state, and the second sub-control 920 is in a gray (untriggerable) state. The operation management control element 900 in the first style 901 indicates that a current operation node is at a very end of a node recording list, has historical content that may be undone, and has no historical content that may be redone; in an operation management control element 900 in a second style 902, the first sub-control 910 and the second sub-control 920 are in the triggerable state. The operation management control element 900 in the second style 902 indicates that the current operation node is at a position of the node recording list that is not a head or a tail of the node recording list, has the historical content that may be undone, and has historical content that may be redone; in an operation management control element 900 in a third style 903, the first sub-control 910 is in the gray state, and the second sub-control 920 is in the triggerable state. The operation management control element 900 in the third style 903 indicates that the current operation node is at a very front of the node recording list, has the historical content that may be redone, and has no historical content that may be undone; and in an operation management control element 900 in a fourth style 904, the first sub-control 910 and the second sub-control 920 are in the gray state. The operation management control element 900 in the fourth style 904 indicates that the current operation node is null (e.g., no recorded list is generated yet), and there is currently no historical content that may be undone and no historical content that may be redone.

Operation 821: Display the slider component element in response to receiving a first triggering operation for the operation management control element.

In this embodiment of this disclosure, the precise undo and redo functions are achieved through the first triggering operation on the operation management control element. In some embodiments, the first triggering operation may be implemented as a touch operation that is received on a terminal screen and that is for the operation management control element. Alternatively, the foregoing first triggering operation may be implemented as a shortcut key triggering operation for the operation management control element that is received by a physical key or an external input device of the terminal. For example, the terminal receives a long-press operation collected by a mouse for the operation management control element. Alternatively, the foregoing first triggering operation may be implemented as a gesture operation recognized by the terminal through a camera. For example, a virtual reality (VR) device detects that the user gazes at the operation management control element, and determines that the first triggering operation for the operation management control element is received when detecting a pinch gesture of the user through image recognition.

In some embodiments, the slider component element includes a slider progress bar, a slider control element, and a reference ruler. The slider progress bar is configured to indicate an operation range in which undo and redo functions can be implemented, and the slider control element is configured to receive a sliding operation to determine a first operation node. The reference ruler is configured to display reference points respectively corresponding to a plurality of historical operation nodes, facilitating a user to more easily and accurately learn a quantity of historical operation nodes and a position of a current operation node.

In some embodiments, determining the at least one historical operation node based on at least one node determining condition in response to receiving the first triggering operation for the operation management control element, the node determining condition being configured to indicate a division condition of a content editing operation on the first content in the historical period, and display the slider component element based on the at least one historical operation node. In some examples, the at least one historical operation node includes a plurality of historical operation nodes. In some examples, a set of historical operation records of the first content is obtained, the set of historical operation records including the one or more content editing operations that are performed on the first content within the recording period. In some examples, the set of historical operation records is divided into a plurality of candidate historical operations based on an operation splitting scale indicated by the division condition. In some examples, the plurality of historical operation nodes that corresponds to the plurality of candidate historical operations is determined.

In some embodiments, the node determining condition may be implemented as at least one of the following.

First, an operation is used as a division scale to determine the historical operation node.

In some aspects, a set of historical operation records (or also referred to as a historical operation set in this disclosure) of the first content is obtained, the historical operation set is a historical editing operation received in a historical period on the first content; and an operation splitting scale is obtained, the operation splitting scale being configured to indicate that the historical operation set is divided into a plurality of candidate historical operations respectively corresponding to the historical operation nodes, and determine the at least one historical operation node based on the operation splitting scale and the historical operation set. In other words, a minimum operation change that may be divided is determined based on an operation splitting scale, and the historical operation set is divided through the minimum operation change that may be divided, to determine the at least one historical operation node.

In some embodiments, the operation splitting scale includes at least one of the following.
1. A first splitting scale based on a numerical content change in the first content (e.g., the historical operation set is split according to adjustment and the change of the numerical content change in the first content). In some aspects, a first editing operation having the numerical content change in the historical operation set is detected, and the historical operation set is divided based on the first editing operation, so that historical operation nodes respectively corresponding to first editing operations are obtained. For example, the historical operation set includes a historical operation 1, a historical operation 2, …, and a historical operation n. When numerical content of first content under the historical operation 1 to the historical operation 4 does not change, numerical content of first content under the historical operation 5 changes, and changes again under the historical operation 8. Therefore, corresponding historical operation nodes are respectively generated based on the historical operation 1, the historical operation 5, and the historical operation 8.
2. A second splitting scale based on a change in natural language text in the first content (e.g., the historical operation set is split according to a change state of the natural language text in the first content). In some aspects, a second editing operation having the change in the natural language text in the historical operation set is detected, and the historical operation set is divided based on the second editing operation, so that historical operation nodes respectively corresponding to second editing operations are obtained. For example, the historical operation set includes a historical operation 1, a historical operation 2, …, and a historical operation n. When natural language text in the first content does not change under the historical operation 1 to the historical operation 3, natural language text in the first content changes under the historical operation 4. Corresponding historical operation nodes are respectively generated based on the historical operation 1 and the historical operation 4.
3. A third splitting scale based on a change in a quantity of pixels in the first content (e.g., the historical operation set is split according to the change in the quantity of pixels in the first content). In some aspects, a third editing operation having the change in the quantity of pixels in the historical operation set is detected, and the historical operation set is split based on the third editing operation, so that historical operation nodes respectively corresponding to third editing operations are obtained. In some embodiments, the third editing operation is an editing operation in which the quantity of pixels changes to reach a specified threshold of the quantity of pixels.
4. A fourth splitting scale based on a change in an operation type of a historical editing operation on the first content (e.g., the historical operation set is split according to a change state of the operation type when an editing operation is performed on the first content). In some aspects, a fourth editing operation having the change in the operation type in the historical operation set is detected, and the historical operation set is split based on the fourth editing operation, so that historical operation nodes respectively corresponding to fourth editing operations are obtained. For example, the historical operation set includes an input operation 1, an input operation 2, a pasting operation 1, a line change operation 1, …, and corresponding historical operation nodes are respectively generated based on the input operation 1, the pasting operation 1, and the line change operation 1.

When an operation is used as the division scale to determine the historical operation node, the user may quickly reach required historical content of the historical editing operation when implementing the undo/redo functions. In addition, when the operation is used as the division scale, a historical editing operation indicated by the historical operation node may be more accessible to a user, thereby facilitating processing efficiency and usability.

Second, time is used as a division scale to determine the historical operation node.

In some aspects, a content processing copy of the first content at a recording interval (e.g., a first duration) is consecutively stored as a time interval in the process of editing the first content; and at least one content processing copy stored in the historical period is obtained when the historical operation node is determined; and historical operation nodes respectively corresponding to the at least one content processing copy are determined, the content processing copy and the historical operation node are in a one-to-one correspondence. In some examples, revisions of the first content are consecutively stored based on a recording interval during the process of editing the first content. In some examples, at least one of the stored revisions recorded within the recording period is obtained, and the at least one historical operation node is determined as corresponding to the at least one of the stored revisions. In some examples, the content processing copy (e.g., a previous revision of the first content) is stored, so that when the first historical content is subsequently restored through the first operation node, efficiency of restoring the first historical content is improved. The computer device can query corresponding first historical content from the stored content processing copy, thereby reducing background operation steps when the first historical content is redone.

In some embodiments, first duration is determined based on a content processing speed. In some aspects, a content processing speed of the first content is obtained in the process of editing the first content; and the first duration based on the content processing speed is determined, the first duration being negatively correlated to the content processing speed. In some embodiments, the content processing speed may be determined based on an increase speed of a size of the content, or the content processing speed may be determined based on an input speed of the content editing operation in the historical operation set of the first content.

In some embodiments, the content processing speed is converted into the recording interval (e.g., the first duration) through a preset duration conversion function. In other words, the content processing speed is input into the preset duration conversion function, to obtain the first duration. When the preset duration conversion function converts the content processing speed into the first duration, the obtained first duration is in a negative correlation with the input content processing speed. In other words, by dynamically generating the first duration of the storage content processing copy according to the content processing speed, when the content processing speed is fast, inability to meet redo and undo requirements of a user due to an insufficient quantity of storage content copies generated is avoided. In addition, waste of computer device storage resources due to an excessive quantity of storage content copies generated is avoided when the content processing speed is slow.

When time is used as the division scale to determine the historical operation, the user may roll back the first content to a specified moment in the historical period, thereby facilitating the user to grasp processing progresses and processing effects at different moments while keeping time sequentially between historical operation nodes.

In some aspects, after the historical operation is obtained through division, the slider component element displayed based on the at least one historical operation node is implemented as: A mapping relationship table between the historical operation node and a reference scale is established, the mapping relationship table is stored to a storage area of the computer device, and the mapping relationship table is updated when a new historical operation node is generated; and the slider progress bar, the slider control element, and the reference ruler are displayed according to a determined reference scale.

In some embodiments, the operation management control element includes the slider control element, and the first triggering operation may be implemented as a control sliding operation for the slider control element. In some aspects, the slider component element is displayed in response to receiving the control sliding operation for the slider control element. In other words, when the slider control element in the operation management control element receives the sliding operation, the slider component element is displayed. The slider component element also includes the slider control element, and the slider control element moves on the slider progress bar.

In some other embodiments, the first triggering operation is an operation directly implemented for a control triggering operation of the operation management control element. In an example, the slider component element is displayed in response to receiving a control long-press operation for the operation management control element.

Operation 822: Receive a sliding operation on the slider component element.

In this embodiment of this disclosure, the sliding operation is configured to determine the first operation node from the at least one historical operation node. In other words, the client determines the first operation node from the at least one historical operation node based on a received sliding operation on the slider component element.

In some embodiments, the foregoing sliding operation may be implemented as a touch sliding operation for the slider component element received by a screen of a terminal. Alternatively, the foregoing sliding operation may be implemented as a shortcut key triggering operation for the slider component element that is received by a physical key or an external input device of the terminal. For example, the terminal receives a long-press and dragging operation collected by a mouse for the slider component element. Alternatively, the foregoing sliding operation may be implemented as a sliding gesture operation recognized by the terminal through a camera. For example, a virtual reality (VR) device detects that the user gazes at the slider component element, and determines that the sliding operation for the slider component element is received when detecting a pinch and dragging gesture of the user through image recognition.

Operation 823: Display first historical content based on the first operation node.

In this embodiment of this disclosure, the first operation node is a node generated according to a first content editing operation recorded at the first moment in the historical period, the first historical content being content obtained after a first content editing operation is performed on the first content at the first moment.

In some embodiments, based on a second recording position of the first operation node in the node recording list, an operation management control element associated with the second recording position is displayed. In other words, after precise undo and redo functions are implemented through the slider component element, display of the operation management control element is restored. A display style of the operation management control element is determined by a position of the first operation node in the node record list.

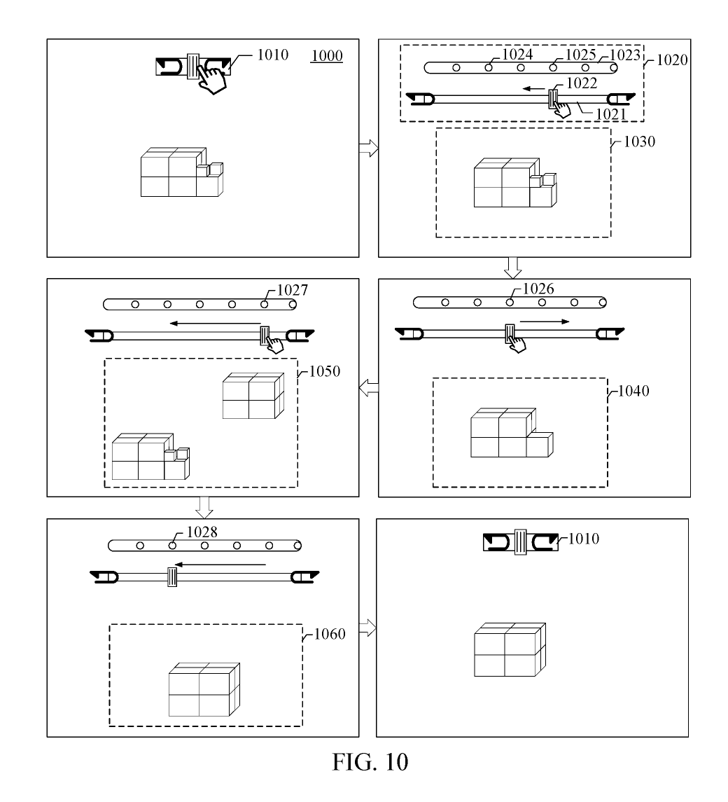

In an example, as shown in FIG. 10, FIG. 10 is a schematic flowchart of precise undo and redo functions implemented through a slider component element according to an embodiment of this disclosure. An example in which a content production application is implemented as a modeling application is used. A modeling process performed by a user for 3D content is shown in FIG. 7, and details are not described herein again. In some aspects, an operation management control element 1010 is displayed on a content editing interface 1000. After the operation management control element 1010 receives a long-press operation, a slider component element 1020 is invoked. The slider component element 1020 includes a slider progress bar 1021, a slider control element 1022, and a reference ruler 1023. A plurality of historical operation nodes 1024 are displayed on the reference ruler 1023.

In some aspects, in this case, the 3D content is located at an operation node 1025 at which operation 4 is located, historical content 1030 corresponding to operation 4 is displayed in the content editing interface 1000. When the slider control element 1022 receives a sliding operation of the user, the slider control element 1022 slides leftward by one grid to an operation node 1026 corresponding to operation 3. In this case, historical content 1040 corresponding to the operation node 1026 is displayed. The historical content 1040 is content corresponding to operation 3.

Then, the slider control element 1022 receives the sliding operation of the user, slides rightward by two grids to an operation node 1027 corresponding to operation five, and displays historical content 1050 corresponding to the operation node 1027. So far, the slider control element 1022 receives the sliding operation of the user, slides leftwards by three grids to an operation node 1028 corresponding to operation 2, and displays historical content 1060 corresponding to the operation node 1028.

After the slider control element 1022 does not receive the sliding operation within specified duration, the operation management control element 1010 is displayed.

Operation 831: Display the first content and second historical content corresponding to a second operation node in response to receiving a second triggering operation for the operation management control element.

In this embodiment of this disclosure, quick undo/redo functions are implemented through the first triggering operation on the operation management control element. The second operation node is a neighboring node of a current operation node of the first content.

In some embodiments, the second triggering operation may be implemented as a touch operation that is received on a terminal screen and that is for the operation management control element. Alternatively, the foregoing second triggering operation may be implemented as a shortcut key triggering operation for the operation management control element that is received by a physical key or an external input device of the terminal. For example, the terminal receives a long-press operation collected by a mouse for the operation management control element. Alternatively, the foregoing second triggering operation may be implemented as a gesture operation recognized by the terminal through a camera. For example, a virtual reality (VR) device detects that the user gazes at the operation management control element, and determines that the second triggering operation for the operation management control element is received when detecting a pinch gesture of the user through image recognition.

In this embodiment of this disclosure, the first triggering operation and the second triggering operation are implemented as different operations for the operation management control element. In an example, the first triggering operation is implemented as a long-press operation for the operation management control element, and the second triggering operation is implemented as a tapping operation for the operation management control element.

In some embodiments, the operation management control element includes a first sub-control and a second sub-control. The first sub-control is configured to implement the undo function, and the second sub-control is configured to implement the redo function. In some aspects, in response to that the first sub-control receives the second triggering operation, displayed second historical content is content under a second content editing operation corresponding to a previous operation node of the current operation node of the first content. In response to that the second sub-control receives the second triggering operation, the displayed second historical content is content under a third content editing operation corresponding to a next operation node of the current operation node of the first content.

In some embodiments, the first content corresponds to the node recording list, the node recording list be configured to record the operation node of the first content in the editing process. In some aspects, when a recording sequence of the operation nodes in the node recording list is negatively correlated to a display sequence, when the first recording position corresponding to the current operation node of the first content is a head position in a queue of the node recording list, the second operation node may be implemented as a node corresponding to a previous recorded content editing operation of the current operation node. When the first recording position corresponding to the current operation node of the first content is a tail position in the queue of the node record list, the second operation node may be implemented as a node corresponding to a next recorded content editing operation of the current operation node. When the first record position corresponding to the current operation node of the first content is an intermediate position in a queue in the node record list, the second operation node may be implemented as a node corresponding to a content editing operation recorded next or previous to the current operation node. In some aspects, when the recording sequence of operation nodes in the node recording list is positively correlated to the display sequence, when the first recording position corresponding to a current operation node of the first content is the head position in the queue of the node record list, the second operation node may be implemented as the next recorded content editing operation of the current operation node. When the first recording position corresponding to the current operation node of the first content is the tail position in the queue of the node recording list, the second operation node may be implemented as the previous recorded content editing operation of the current operation node. When the first recording position corresponding to the current operation node of the first content is the intermediate position in the queue of the node recording list, the second operation node may be implemented as the node corresponding to the content editing operation recorded next or previous to the current operation node.

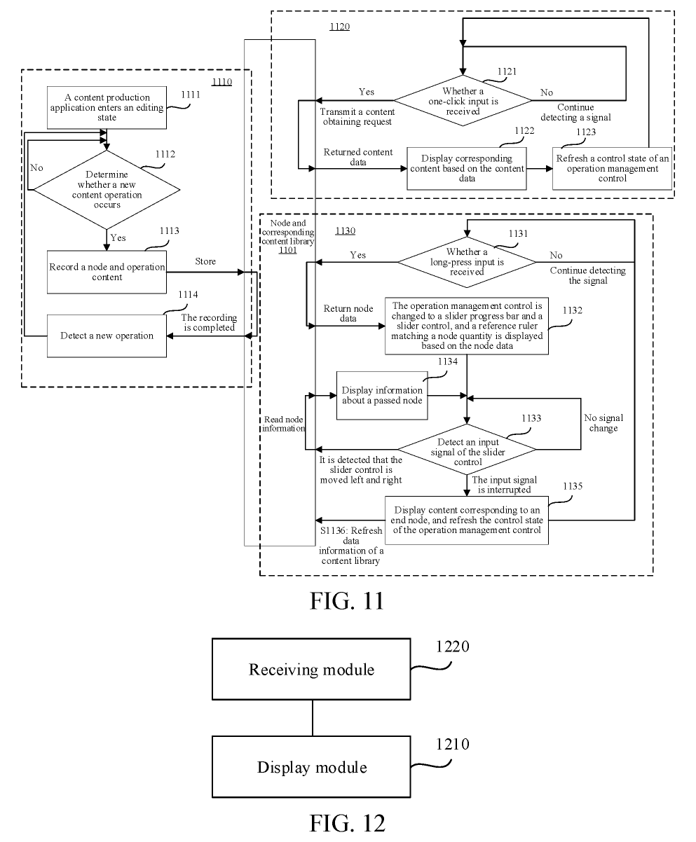

In an example, as shown in FIG. 11, FIG. 11 is a determining logic flowchart of an operation management control element according to an embodiment of this disclosure. The process includes an editing operation recording part 1110, a single-click undo and redo function part 1120, and a long-press undo and redo function part 1130.

In some aspects, the editing operation recording part 1110 includes: S1111: A content production application enters an editing state; S1112: Determine whether a new content operation occurs, and if no, continue perform S1112, or if yes, perform S1113; S1113: Record a node and operation content, and store the node and the operation content in a node and a corresponding content library 1101; and S1114: Detect a new operation when the recording is completed.

The single-click undo and redo function part 1120 includes: S1121: Determine whether a single-click input is received, and if no, continue detecting a signal, or if yes, transmit a content obtaining request to the node and the corresponding content library 1101; S1122: Receive content data returned by the node and the corresponding content library 1101, and display corresponding content based on the content data; and S1123: Refresh control state of the operation management control element.

The long-press undo and redo function part 1130 includes: S1131: Determine whether a long-press input is received, and if no, continue detecting a signal, or if yes, transmit a node obtaining request to the node and the corresponding content library 1101; S1132: Receive the node and node data returned by the corresponding content library 1101, so that the operation management control element is changed to a slider progress bar and a sliding control, and a reference ruler matching a node quantity is displayed based on the node data; S1133: Detect an input signal of the sliding control, and if there is no signal change, continue performing S1133, or if it is detected that the sliding control is moved left and right, read node information and content data of a node passed by a corresponding sliding control from the node and the corresponding content library 1101; S1134: Display node information about the passed node; S1135: Display content corresponding to an end node when the input signal is interrupted, and refresh the control state of the operation management control element; and S1136: Refresh the data information of the node and the corresponding content library 1101.

Therefore, in a process of editing content, when a content editing operation performed on the content needs to be undone or redone, current content is reverted or restored to historical content under content editing operations corresponding to different historical operation nodes in a historical period through a sliding operation for a slider component element. In this way, in one aspect, a user can quickly implement a multi-operation undo or redo operation through the slider component element, thereby improving efficiency of interaction implemented by undo and redo functions; in another aspect, because the computer device may detect an operation signal of the sliding operation to determine a quantity of undone or redone operation steps, redundant processing of an intermediate operation that would otherwise be performed by receiving triggering signals for a plurality of times may be omitted, thereby reducing a quantity of operations detected by the computer equipment; and in still another aspect, the computer device may determine a first operation node according to the sliding operation for the slider component element, and directly presents corresponding first historical content based on the first operation node. In this way, in a scenario of multi-operation undo or redo, historical content corresponding to an intermediate operation that needs to be reverted when the computer device responds to each operation may be omitted, and a data processing amount in response to multi-operation undo or redo operations may be reduced.

In this embodiment of this disclosure, quick undo and redo functions or precise undo and redo functions are implemented through different triggering operations of the operation management control element. In this way, a user can meet different undo and redo requirements in different requirement scenarios through the operation management control element, thereby reducing a typesetting requirement of an interface display control, and improving utilization of the control when a function is provided.

Referring to FIG. 12, FIG. 12 is a structural block diagram of a content editing apparatus according to an embodiment of this disclosure. The apparatus includes the following modules:
a display module 1210, configured to display a slider component element corresponding to first content in a process of editing the first content, the slider component element including at least one historical operation node, and the historical operation node being a node that is recorded in a historical period and that is generated when a content editing operation is performed on the first content;
a receiving module 1220, configured to receive a sliding operation on the slider component element, the sliding operation being configured to determine a first operation node from the at least one historical operation node of the slider component element; and
the display module 1210, further configured to display first historical content based on the first operation node, the first operation node being a node generated according to a first content editing operation recorded at a first moment in the historical period, and the first historical content being content obtained after a first content editing operation is performed on the first content at the first moment.

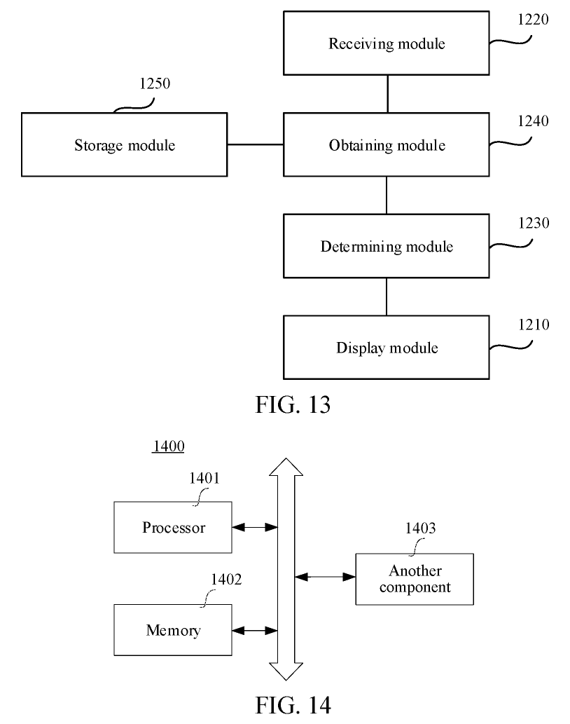

In some embodiments, the slider component element includes a slider progress bar and a slider control element;
the receiving module 1220 is further configured to receive a sliding operation performed on the slider control element on the slider progress bar;
and as shown in FIG. 13, the apparatus further includes:
a determining module 1230, configured to determine the first operation node based on a sliding end position of the sliding operation on the slider progress bar.

The display module 1210, further configured to display a node identifier of a passed historical operation node in a sliding path based on screen blocking information and the sliding path.

In some embodiments, the slider component element further includes a reference ruler, the reference ruler including reference scales respectively corresponding to a plurality of historical operation nodes; and

the determining module 1230 is further configured to determine the sliding end position of the sliding operation on the slider progress bar; determine a reference position corresponding to the sliding end position on the reference ruler; and determine the first operation node from the plurality of historical operation nodes based on a reference scale corresponding to the reference position.

In some embodiments, the display module 1210 is further configured display an operation management control element corresponding to the first content in the process of editing the first content, the operation management control element being configured to manage a content editing operation of the first content in the historical period; and display the slider component element in response to receiving a first triggering operation performed on the operation management control element.

In some embodiments, the operation management control element includes a slider control element; and

the display module 1210 is further configured to display the slider component element in response to receiving a control sliding operation for the slider control element; and

the display module 1210 is further configured to display the slider component element in response to receiving a long-press operation for the operation management control element.

In some embodiments, the determining module 1230 is further configured to determine the at least one historical operation node based on at least one node determining condition in response to receiving the first triggering operation for the operation management control element, the node determining condition being configured to indicate a division condition of a content editing operation on the first content in the historical period; and

the display module 1210 is further configured to display the slider component element based on the at least one historical operation node.

In some embodiments, the apparatus further includes:
an obtaining module 1240, configured to obtain a historical operation set (e.g., a set of historical operation records) of the first content, the historical operation set including historical editing operations that are performed on the first content and that are received in the historical period; and obtain an operation splitting scale, the operation splitting scale being configured to indicate that the historical operation set is divided into a plurality of candidate historical operations respectively corresponding to the historical operation nodes; and
the determining module 1230, further configured to determine the at least one historical operation node based on the operation splitting scale and the historical operation set.

In some embodiments, the operation splitting scale includes at least one of the following:
a first splitting scale based on a change in numeric content in the first content;
a second splitting scale based on a change in natural language text in the first content;
a third splitting scale based on a change in a quantity of pixels in the first content; and
a fourth splitting scale based on a change in an operation type of a historical editing operation performed on the first content.

In some embodiments, the apparatus further includes:
a storage module 1250, configured to consecutively store a content processing copy of the first content at first duration as a time interval in the process of editing the first content; and
the obtaining module 1240, further configured to obtain at least one content processing copy stored in the historical period; and
the determining module 1230, further configured to determine historical operation nodes respectively corresponding to the at least one content processing copy, the content processing copy and the historical operation node are in a one-to-one correspondence.

The obtaining module 1240 is further configured to, in some embodiments, obtain a content processing speed of the first content in the process of editing the first content; and

the determining module 1230 is further configured to determine first duration based on the content processing speed, the first duration being negatively correlated to the content processing speed.

In some embodiments, the display module 1210 is further configured to display the first content and second historical content corresponding to a second operation node in response to receiving a second triggering operation for the operation management control element, the second operation node being an adjacent node of a current operation node of the first content.

In some embodiments, the first content corresponds to a node recording list, the node recording list be configured to record an operation node of the first content in an editing process; and

the obtaining module 1240 is further configured to obtain a first recording position of the current operation node of the first content in the node recording list; and

the display module 1210 is further configured to display the operation management control element associated with the first recording position.

In some embodiments, the display module 1210 is further configured to display an operation management control element in a first style when the first recording position is a head position in a queue of the node recording list, the operation management control element in the first style being configured to provide an operation undo function (e.g., configured to receive an instruction of an undo function); display an operation management control element in a second style when the first recording position is an intermediate position in the queue of the node recording list, the operation management control element in the second style being configured to provide the operation undo function (e.g., configured to receive an instruction of the undo function) or an operation redo function (e.g., configured to receive an instruction of a redo function); and display an operation management control element in a third style when the first recording position is a tail position in the queue of the node recording list, the operation management control element in the third style being configured to provide the operation redo function (e.g., configured to receive an instruction of the redo function).

In some embodiments, the display module 1210 is further configured to display an operation management control element associated with the second recording position based on a second recording position of the first operation node in the node recording list.

In some embodiments, the determining module 1230 is further configured to perform screen blocking detection based on the sliding operation, to obtain screen blocking information, the screen blocking information being configured to indicate an area in which a screen is blocked when the sliding operation is received;

the determining module 1230 is further configured to perform sliding path detection based on the sliding operation, to obtain a sliding path corresponding to the sliding operation; and

the display module 1210 is further configured to display a node identifier of a passed historical operation node at the second display position if the screen blocking information indicates that the first display position corresponding to the historical operation node passed on the sliding path is blocked, the first display position is a default display position of the node identifier.

Therefore, in a process of editing content, when a content editing operation performed on the content needs to be undone or redone, current content is reverted or restored to historical content under content editing operations corresponding to different historical operation nodes in a historical period through a sliding operation for a slider component element. In this way, in one aspect, a user can quickly implement a multi-operation undo or redo operation through the slider component element, thereby improving efficiency of interaction implemented by undo and redo functions; in another aspect, because the computer device may detect an operation signal of the sliding operation to determine a quantity of undone or redone operation steps, redundant processing of an intermediate operation that would otherwise be performed by receiving triggering signals for a plurality of times may be omitted, thereby reducing a quantity of operations detected by the computer equipment; and in still another aspect, the computer device may determine a first operation node according to the sliding operation for the slider component element, and directly presents corresponding first historical content based on the first operation node. In this way, in a scenario of multi-operation undo or redo, historical content corresponding to an intermediate operation that needs to be reverted when the computer device responds to each operation may be omitted, and a data processing amount in response to multi-operation undo or redo operations may be reduced.

The content editing apparatus provided in one or more embodiments in this disclosure is illustrated with an example of division of the foregoing functional modules. In an actual application, the functions may be allocated to and completed by different functional modules according to requirements (e.g., an internal structure of the device is divided into different functional modules), to implement all or some of the foregoing functions. In addition, the content editing apparatus provided in one or more embodiments in this disclosure belongs to the same idea as the content editing method embodiments. For a specific implementation thereof, reference may be made to the method embodiments.

Modules, submodules, and units described in this disclosure can be implemented by processing circuitry (e.g., one or more processors, controllers, or application-specific integrated circuits), software (e.g., instructions stored on a non-transitory computer-readable storage medium), or a combination thereof. Software modules may be stored in memory and executed by a processor to perform the functions of the respective modules. Hardware modules may include dedicated processing circuitry configured to perform specific functions. The relationship between software modules and hardware modules is not one-to-one; a single software module may be executed by multiple processors, and a single processor may execute multiple software modules.

As used in this disclosure, “at least one of A, B, or C” is intended to include A alone, B alone, C alone, any combination of A and B, any combination of A and C, any combination of B and C, or any combination of A, B, and C. Similarly, “one of A and B” is intended to include A, B, or both A and B.

FIG. 14 is a structural block diagram of a terminal 1400 according to an embodiment of this disclosure. The terminal 1400 may be a smartphone, a tablet computer, a moving picture experts group audio layer III (MP3) player, a moving picture experts group audio layer IV (MP4) player, a laptop computer, or a desktop computer. The terminal 1400 may alternatively be referred to as another name such as a user equipment, a portable terminal, a laptop terminal, or a desktop terminal.

Generally, the terminal 1400 includes: processing circuitry (e.g., a processor 1401) and a memory 1402 (e.g., including a non-transitory computer-readable storage medium).

The processor 1401 may include one or more processing cores, and may be, for example, a 4-core processor or an 8-core processor. In some embodiments, the processor 1401 may be integrated with a graphics processing unit (GPU). The GPU is configured to render and draw content that needs to be displayed on a display screen. In some embodiments, the processor 1401 may further include an artificial intelligence (AI) processor. The AI processor is configured to process computing operations related to machine learning.

The memory 1402 may include one or more non-transitory computer-readable storage media. In some embodiments, the non-transitory computer-readable storage medium in the memory 1402 is configured to store at least one instruction, the at least one instruction being configured to be executed by the processor 1401 to implement a content editing method provided in this disclosure.

In some aspects, the terminal 1400 further includes another component 1403. A person skilled in the art may understand that the structure shown in FIG. 14 constitutes no limitation on the terminal 1400, and the terminal 1400 may include more or fewer components than components shown in the figure, or some components may be combined, or a different component deployment may be used.

A person of ordinary skill in the art may understand that all or some of the operations of the methods in one or more embodiments in this disclosure may be implemented by a program instructing relevant hardware. The program may be stored in a non-transitory computer-readable storage medium. The non-transitory computer-readable storage medium may be the non-transitory computer-readable storage medium included in the memory in one or more embodiments in this disclosure; or may be a non-transitory computer-readable storage medium that exists independently and that is not assembled in a terminal. The non-transitory computer-readable storage medium stores at least one instruction, at least one segment of program, and a code set or an instruction set, the at least one instruction, the at least one segment of program, and the code set or the instruction set being loaded and executed by the processor to implement a content editing method based on one or more embodiments in this disclosure.

In some embodiments, the non-transitory computer-readable storage medium may include: a read only memory (ROM), a random access memory (RAM), a solid state drive (SSD), an optical disc, or the like.

What is claimed is:

1. A content editing method, the method comprising:
displaying an operation management control element corresponding to first content in a process of editing the first content;
displaying a slider component element when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment;
when the slider component element is displayed,
receiving a sliding operation on the slider component element corresponding to moving the slider control element along the slider progress bar, and
displaying a first revision of the first content at a first moment represented by a first operation node when the slider control element indicates selection of the first operation node from the at least one historical operation node; and
displaying a second revision of the first content at a second moment adjacent to a currently displayed revision of the first content at a currently displayed moment when a second triggering operation is performed on the operation management control element.

2. The method according to claim 1, further comprising:
when the slider component element is displayed, determining whether the slider control element indicates the selection of the first operation node based on a sliding end position of the sliding operation on the slider progress bar.

3. The method according to claim 2, wherein
the slider component element further includes a reference ruler, the reference ruler including reference markings respectively corresponding to a plurality of historical operation nodes; and
the determining whether the slider control element indicates the selection of the first operation node includes:
determining the sliding end position of the sliding operation on the slider progress bar;
determining a reference position on the reference ruler corresponding to the sliding end position; and
determining the selection of the first operation node from the plurality of historical operation nodes based on a reference marking corresponding to the reference position.

4. The method according to claim 1, wherein
the operation management control element includes the slider control element; and
the first triggering operation includes:
a control sliding operation performed on the slider control element; or
a long-press operation performed on the operation management control element.

5. The method according to claim 1, further comprising:
determining the at least one historical operation node based on at least one node determining condition when the first triggering operation is performed on the operation management control element, the node determining condition indicating a division condition of one or more content editing operations performed on the first content within the recording period.

6. The method according to claim 5, wherein
the at least one historical operation node includes a plurality of historical operation nodes; and
the determining the at least one historical operation node comprises:
obtaining a set of historical operation records of the first content, the set of historical operation records including the one or more content editing operations that are performed on the first content within the recording period;
dividing the set of historical operation records into a plurality of candidate historical operations based on an operation splitting scale indicated by the division condition; and
determining the plurality of historical operation nodes that corresponds to the plurality of candidate historical operations.

7. The method according to claim 6, wherein the operation splitting scale includes:
a first splitting scale based on a change in numeric content in the first content;
a second splitting scale based on a change in natural language text in the first content;
a third splitting scale based on a change in a quantity of pixels in the first content; or
a fourth splitting scale based on a change in an operation type of a content editing operation performed on the first content.

8. The method according to claim 5, further comprising:
consecutively storing revisions of the first content based on a recording interval during the process of editing the first content; and
the determining the at least one historical operation node based on at least one node determining condition comprises:
obtaining at least one of the stored revisions recorded within the recording period; and
determining the at least one historical operation node as corresponding to the at least one of the stored revisions.

9. The method according to claim 8, further comprising:
obtaining a content processing speed of the first content in the process of editing the first content; and
determining the recording interval based on the content processing speed, the recording interval being negatively correlated to the content processing speed.

10. The method according to claim 1, wherein the displaying the operation management control element comprises:
obtaining a first recording position of a currently displayed operation node of the first content in a node recording list; and
displaying the operation management control element based on the first recording position in the node recording list.

11. The method according to claim 10, wherein the displaying the operation management control element based on the first recording position in the node recording list comprises:
displaying the operation management control element in a first style when the first recording position is a head position in a queue of the node recording list, the operation management control element in the first style being configured to receive an instruction of an undo function;
displaying the operation management control element in a second style when the first recording position is an intermediate position in the queue of the node recording list, the operation management control element in the second style being configured to receive the instruction of the operation undo function or an instruction of a redo function; and
displaying the operation management control element in a third style when the first recording position is a tail position in the queue of the node recording list, the operation management control element in the third style being configured to receive the instruction of the redo function.

12. The method according to claim 10, further comprising:
updating display of the operation management control element based on a second recording position of the first operation node in the node recording list after the first revision of the first content is displayed.

13. The method according to claim 1, further comprising:
performing screen blocking detection based on the sliding operation, to obtain screen blocking information, the screen blocking information indicating an area that is blocked when the sliding operation is received;
performing sliding path detection based on the sliding operation, to obtain a sliding path corresponding to the sliding operation; and
displaying, when the screen blocking information indicates that a first display position corresponding to a historical operation node passed on the sliding path is blocked, a node identifier of the passed historical operation node at a second display position, the first display position being a default display position of the node identifier.

14. A content editing apparatus, comprising:
processing circuitry configured to:
display an operation management control element corresponding to first content in a process of editing the first content;
display a slider component element when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment;
when the slider component element is displayed,
receive a sliding operation on the slider component element corresponding to moving the slider control element along the slider progress bar, and
display a first revision of the first content at a first moment represented by a first operation node when the slider control element indicates selection of the first operation node from the at least one historical operation node; and
display a second revision of the first content at a second moment adjacent to a currently displayed revision of the first content at a currently displayed moment when a second triggering operation is performed on the operation management control element.

15. The apparatus according to claim 14, wherein the processing circuitry is configured to:
when the slider component element is displayed
determine whether the slider control element indicates the selection of the first operation node based on a sliding end position of the sliding operation on the slider progress bar.

16. The apparatus according to claim 15, wherein
the slider component element further includes a reference ruler, the reference ruler including reference markings respectively corresponding to a plurality of historical operation nodes; and
the processing circuitry is configured to:
determine a reference position on the reference ruler corresponding to the sliding end position; and
determine the selection of the first operation node from the plurality of historical operation nodes based on a reference marking corresponding to the reference position.

17. The apparatus according to claim 14, wherein
the operation management control element includes the slider control element; and
the first triggering operation includes:
a control sliding operation performed on the slider control element; or
a long-press operation performed on the operation management control element.

18. The apparatus according to claim 14, wherein
the at least one historical operation node includes a plurality of historical operation nodes;
the processing circuitry is configured to:
obtain a set of historical operation records of the first content, the set of historical operation records including one or more content editing operations that are performed on the first content within the recording period;
divide the set of historical operation records into a plurality of candidate historical operations based on an operation splitting scale indicated by a division condition; and
determine the plurality of historical operation nodes that corresponds to the plurality of candidate historical operations.

19. The apparatus according to claim 18, wherein the operation splitting scale includes:
a first splitting scale based on a change in numeric content in the first content;
a second splitting scale based on a change in natural language text in the first content;
a third splitting scale based on a change in a quantity of pixels in the first content; or
a fourth splitting scale based on a change in an operation type of a content editing operation performed on the first content.

20. A non-transitory computer-readable storage medium storing instructions, which when executed by a processor, cause the processor to perform a content editing method, the method comprising:
displaying an operation management control element corresponding to first content in a process of editing the first content;
displaying a slider component element when a first triggering operation is performed on the operation management control element, the slider component element including a slider progress bar, a slider control element over the slider progress bar, and at least one historical operation node, each of the at least one historical operation node representing a revision of the first content at a respective moment within a recording period that is generated when a content editing operation is performed on the first content at the respective moment;
when the slider component element is displayed,
receiving a sliding operation on the slider component element corresponding to moving the slider control element along the slider progress bar, and
displaying a first revision of the first content at a first moment represented by a first operation node when the slider control element indicates selection of the first operation node from the at least one historical operation node; and
displaying a second revision of the first content at a second moment adjacent to a currently displayed revision of the first content at a currently displayed moment when a second triggering operation is performed on the operation management control element.
